(19) United States
(12) Patent Application Publication
(10) Pub. No.: US 2026/0249799 A1
(43) Pub. Date: Aug. 27, 2026

(54) VEHICLE

(71) Applicant: HONDA MOTOR CO., LTD., Tokyo (JP)

(72) Inventors: Takao Mikami, Wako-shi (JP); Noriyuki Mori, Wako-shi (JP); Shinji Kobayashi, Wako-shi (JP)

(21) Appl. No.: 19/450,960

(22) Filed: Jan. 16, 2026

(30) Foreign Application Priority Data
Feb. 25, 2025 (JP) 2025-027649

(51) Int. Cl. B60R 19/52

(52) U.S. Cl. CPC B60R 19/52; B60R 2019/527

(57) ABSTRACT

A vehicle includes a vehicle body frame, left and right front wheels and at least one rear wheel, a radiator, a front cover including a grille portion, a winch, and a bumper. The bumper includes a wind guide portion on a surface overlapping the grille portion in a vehicle front view, and either a guide member or a cover member is selectively provided for either an opening portion or a cutout portion provided below the wind guide portion.

### INCORPORATION BY REFERENCE

The present application claims priority under 35 U.S.C. § 119 to Japanese Patent Application No. 2025-027649 filed on Feb. 25, 2025. The content of the application is incorporated herein by reference in its entirety.

### BACKGROUND

### Technical Field

The present invention relates to a vehicle.

### Related Art

A saddle-ride vehicle in which two or more seats are provided side by side on the left and right, a so-called side-by-side multi utility vehicle (MUV) is conventionally known as a vehicle (see, for example, JP 5837014 B2). JP 5837014 B2 discloses, in a side-by-side MUV in which a radiator is disposed in a hood and a winch is provided below the radiator, a technique of providing a grille portion that introduces traveling wind in a front cover that covers the front of the radiator, and forming vertical wall portions on the left and right of the grille portion, so that the traveling wind can be actively guided to the radiator. Note that in JP 5837014 B2, a bumper is provided on the front of the front cover, and an opening portion for taking out a wire extending from the winch is provided in a central portion of the bumper.

### SUMMARY

In the technique described in JP 5837014 B2, however, the opening portion for taking out the wire is positioned below a lower end of the radiator. The opening portion is formed in the bumper, and thus the traveling wind enters the bumper from the opening portion. However, the traveling wind also flows downward from the lower end of the radiator, thereby leading to loss in guiding the traveling wind from a front end portion of the vehicle to the radiator. In addition, since the bumper has such an opening portion, in a case where the winch is not provided, the opening portion is conspicuous without fulfilling its original function.

The present invention has been made in view of the above circumstances, and an object of the present invention is, in a vehicle in which either an opening portion or a cutout portion for taking out a wire of a winch is provided on a bumper, to enable wind to be guided to a radiator although either the opening portion or the cutout portion is provided, and to also make either the opening portion or the cutout portion less conspicuous in appearance.

A vehicle including: a vehicle body frame; left and right front wheels and at least one rear wheel, which are provided on the vehicle body frame; a radiator disposed between the left and right front wheels; a front cover, which includes a grille portion for introducing traveling wind, which is positioned on front of the radiator, and which covers at least an upper portion of the radiator; a winch disposed below the radiator; and a bumper, which is supported by the vehicle body frame, and which is positioned on the front of the grille portion, in which the bumper includes an opening that forms a wind guide portion on a surface overlapping the grille portion in a vehicle front view, either an opening portion or a cutout portion is provided below the wind guide portion, the opening portion being for taking out a wire of the winch, the cutout portion being connected with the wind guide portion and being for taking out the wire of the winch, and either a guide member to be used when the winch is used or a cover member to be used when the winch is not used is selectively provided for either the opening portion or the cutout portion.

In the vehicle in which either the opening portion or the cutout portion for taking out the wire of the winch is provided on the bumper, it becomes possible to guide the wind to the radiator although either the opening portion or the cutout portion is provided, and to also make either the opening portion or the cutout portion less conspicuous in appearance.

### BRIEF DESCRIPTION OF DRAWINGS

FIG. 1 is a left side view illustrating an irregular ground travel vehicle according to a first embodiment of the present invention;

FIG. 2 is a longitudinal sectional view of a front portion of the irregular ground travel vehicle according to the first embodiment of the present invention;

FIG. 3 is a perspective view corresponding to a cross-section taken along line III-III in FIG. 1;

FIG. 4 is a perspective view of the irregular ground travel vehicle when a peripheral portion of a bumper is viewed from upper left;

FIG. 5 is a front view of the irregular ground travel vehicle, and illustrates a peripheral portion of the bumper;

FIG. 6 is a view illustrating a state in which a guide roller unit is removed from FIG. 5;

FIG. 7 is a perspective view of the irregular ground travel vehicle when the peripheral portion of the bumper, with which a wind guide cover is attached, is viewed from upper left;

FIG. 8 is a front view of the irregular ground travel vehicle, and illustrates the peripheral portion of the bumper in a case where the wind guide cover is attached;

FIG. 9 is a perspective view corresponding to a cross-section taken along line IX-IX in FIG. 8;

FIG. 10 is a perspective view of a peripheral portion of a roof of the irregular ground travel vehicle when viewed from lower left;

FIG. 11 is a perspective view of a clip member;

FIG. 12 is an explanatory view of the clip member of an upper frame and an engagement receiving portion of the roof;

FIG. 13 is an explanatory view when the clip member of the upper frame and the engagement receiving portion of the roof are engaged with each other; and

FIG. 14 is a front view of a bumper in an irregular ground travel vehicle according to a second embodiment of the present invention.

### DETAILED DESCRIPTION

Hereinafter, embodiments of the present invention will be described with reference to the drawings. Note that, in the description, directions such as front, rear, left, right, up, and down are identical to directions with respect to a vehicle body, unless otherwise specified. In the drawings, reference sign FR denotes the front side of the vehicle body, reference sign UP denotes the upper side of the vehicle body, and reference sign LH denotes the left side of the vehicle body.

### First Embodiment

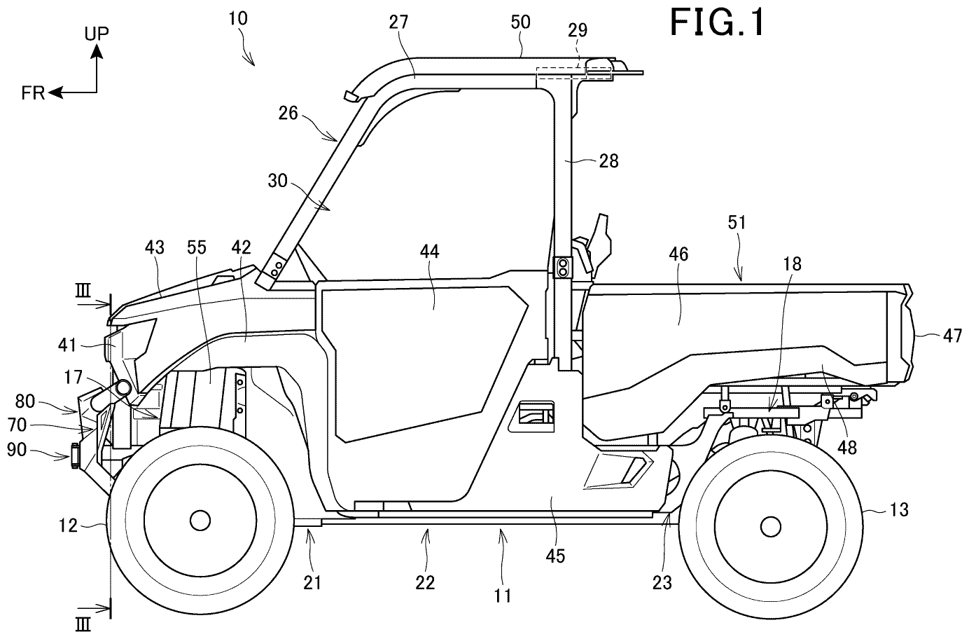

FIG. 1 is a left side view illustrating an irregular ground travel vehicle 10 according to a first embodiment of the present invention.

The irregular ground travel vehicle 10, as an example of the vehicle, is a side-by-side MUV. The irregular ground travel vehicle 10 includes: a vehicle body frame 11; a pair of left and right front wheels 12, which are supported by a front portion of the vehicle body frame 11; a pair of left and right rear wheels 13, which are supported by a rear portion of the vehicle body frame 11; and a power unit (not illustrated) disposed in a lower portion close to the rear of the vehicle body. The irregular ground travel vehicle 10 travels using driving force supplied by the power unit to the front wheels 12 and the rear wheels 13.

The vehicle body frame 11 includes: a front frame 21; a center frame 22, which is connected with a rear portion of the front frame 21; and a rear frame 23, which is connected with a rear portion of the center frame 22. The vehicle body frame 11 also includes the front frame 21, and an upper frame 26, which is attached to extend upward from the center frame 22.

The front wheels 12 are supported by the front frame 21 via a front suspension 17.

The rear wheels 13 are supported by the rear frame 23 via a rear suspension 18.

In a vehicle side view, the upper frame 26 includes: a pair of left and right front pillars 27, which extend rearward and upward from a rear upper portion of the front frame 21 and then extend rearward; a pair of left and right center pillars 28, which respectively extend upward from the center frame 22 and are then connected with rear end portions of the front pillars 27; and a cross frame 29, which connects between rear end portions of the left and right center pillars 28. A roof 50 having a plate shape is attached to the upper side of the upper frame 26.

A cabin 30, which an occupant gets in, is made up of a space surrounded by the front frame 21, the center frame 22, and the upper frame 26.

Seats (not illustrated), on which a driver and a passenger are seated, are disposed inside the cabin 30. The seats are arranged side by side on the left and right. An operation system such as a steering wheel (not illustrated) to be operated by the driver is disposed inside the cabin 30.

The irregular ground travel vehicle 10 includes: a front cover 41, which is provided at a front end portion, and which covers a front end of the irregular ground travel vehicle 10; a front fender 42, which is provided at a rear portion of the front cover 41, and which covers the rear of the front wheel 12 from above the front wheel 12; a front upper cover 43, which is provided above the front fender 42, and which covers a front upper portion of the irregular ground travel vehicle 10; and a front door 44, which is disposed on the rear of the front fender 42, and which is openable and closable via a hinge (not illustrated) at a rear end portion.

The irregular ground travel vehicle 10 also includes: a side cover 45, which is disposed on lower rear of the front door 44, and which covers a lateral portion of the irregular ground travel vehicle 10; a rear side cover 46, which is disposed upper rear of the side cover 45; a rear cover 47, which covers a space between the left and right rear side covers 46 from the rear; and a rear fender 48, which is provided below the rear side covers 46, and which covers the rear wheel 13 from above. The rear side covers 46 and the rear cover 47 cover a cargo bed 51 from the outside. The cargo bed 51 is supported by the rear frame 23. The cargo bed 51 is used as a space for placing a cargo. By disposing a rear seat on the cargo bed 51, another occupant may be seated.

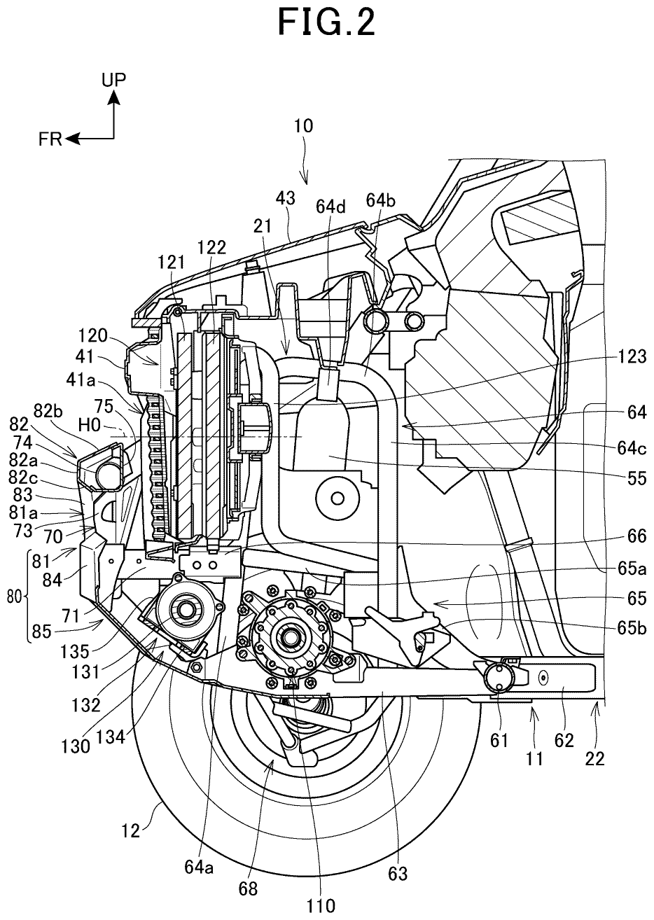

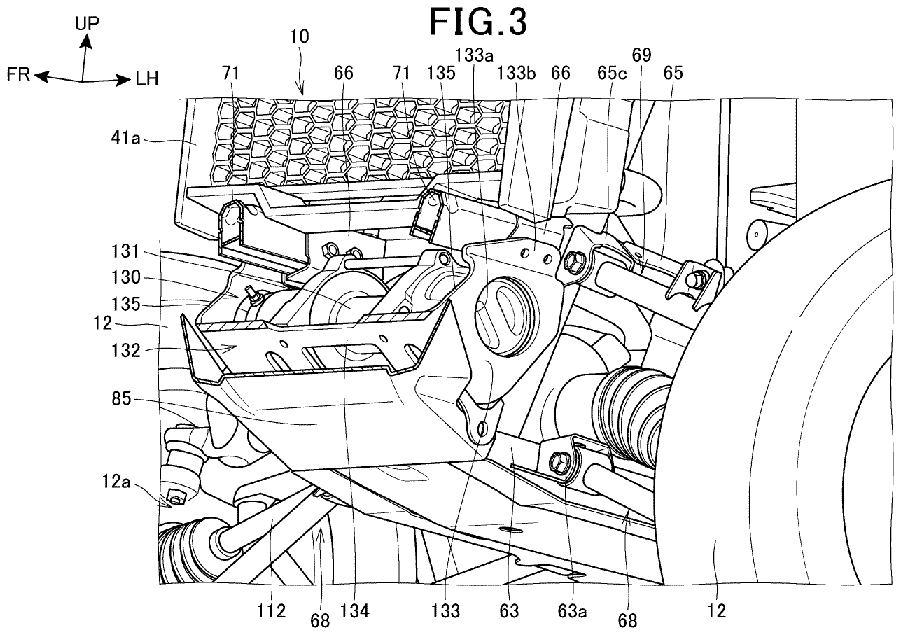

FIG. 2 is a longitudinal sectional view of a front portion of the irregular ground travel vehicle 10 according to the first embodiment of the present invention. FIG. 3 is a perspective view corresponding to a cross-section taken along line III-III in FIG. 1.

The front frame 21 is connected with a front portion of the center frame 22. The front frame 21 includes a front lower cross frame 61, which has a pipe shape, and which is connected with the center frame 22. The front lower cross frame 61 extends in a vehicle width direction. Gusset portions 62 are provided at both ends in the vehicle width direction of the front lower cross frame 61. The gusset portion 62 is fixed over the front lower cross frame 61 and the center frame 22.

A pair of left and right front lower frames 63, which extend forward, are connected with a central portion in the vehicle width direction of the front lower cross frame 61. An arm bracket 63a is provided on each front lower frame 63 (see FIG. 3).

A cushion support frame 64, which has a substantially inverted letter U shape in the vehicle side view, is connected with the front lower frame 63. Specifically, the cushion support frame 64 includes: a pair of front and rear vertical frame portions 64a and 64c, which extend upward from the front lower frame 63; and a lateral frame portion 64b, which extends in a front-rear direction, and which connects between upper ends of the vertical frame portions 64a and 64c. The lateral frame portion 64b supports a cushion support portion 64d.

A front upper frame 65, which extends in the front-rear direction, is connected with the cushion support frame 64. A pair of left and right front upper frames 65 are respectively provided to correspond to the left and right cushion support frames 64. The front upper frame 65 includes: a main body portion 65a, which extends in the front-rear direction; and an inclined portion 65b, which extends rearward and downward from a rear end of the main body portion 65a. The main body portion 65a connects between the front and rear vertical frame portions 64a and 64c of the cushion support frame 64. An arm bracket 65c is provided on the main body portion 65a (see FIG. 3). The inclined portion 65b is connected at a rear end with the front lower frame 63.

A bumper stay 66, which protrudes forward in accordance with a connection position of the main body portion 65a of the front upper frame 65, is provided on the front vertical frame portion 64a of the cushion support frame 64. The bumper stay 66 is formed in a square pipe shape.

As illustrated in FIG. 3, a front wheel lower arm 68 is swingably supported by the arm bracket 63a of the front lower frame 63. In addition, a front wheel upper arm 69 is swingably supported by the arm bracket 65c of the front upper frame 65. The front wheel lower arm 68 and the front wheel upper arm 69 support the front wheel 12 to be rotatable via a knuckle 12a (see the front wheel 12 on the right).

In addition, an upper end of a front cushion unit 55 is coupled with the cushion support portion 64d of the cushion support frame 64. A lower end of the front cushion unit 55 is coupled with the front wheel upper arm 69.

The front wheel lower arm 68, the front wheel upper arm 69, the front cushion unit 55, the knuckle 12a, and the like constitute the front suspension 17 according to the present embodiment.

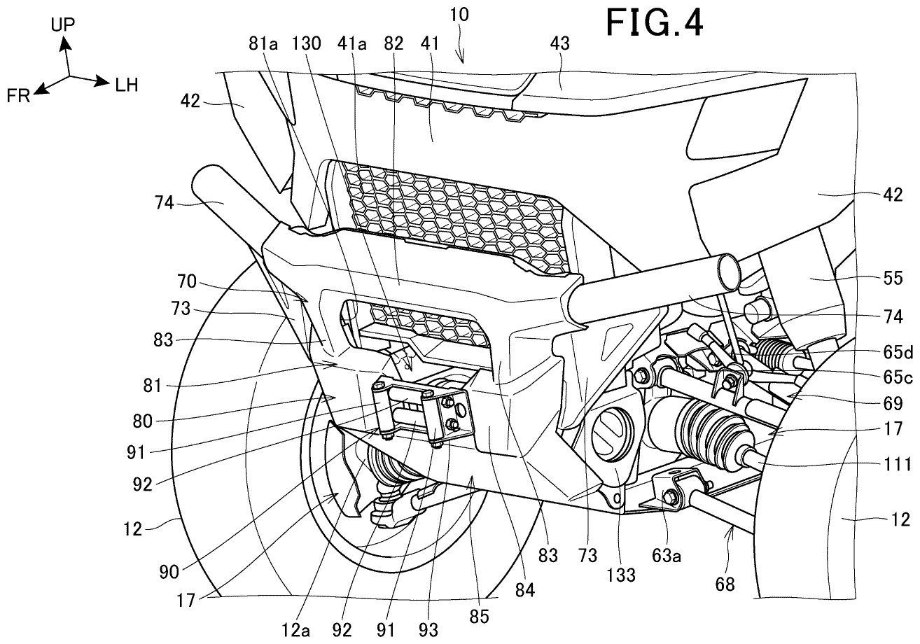

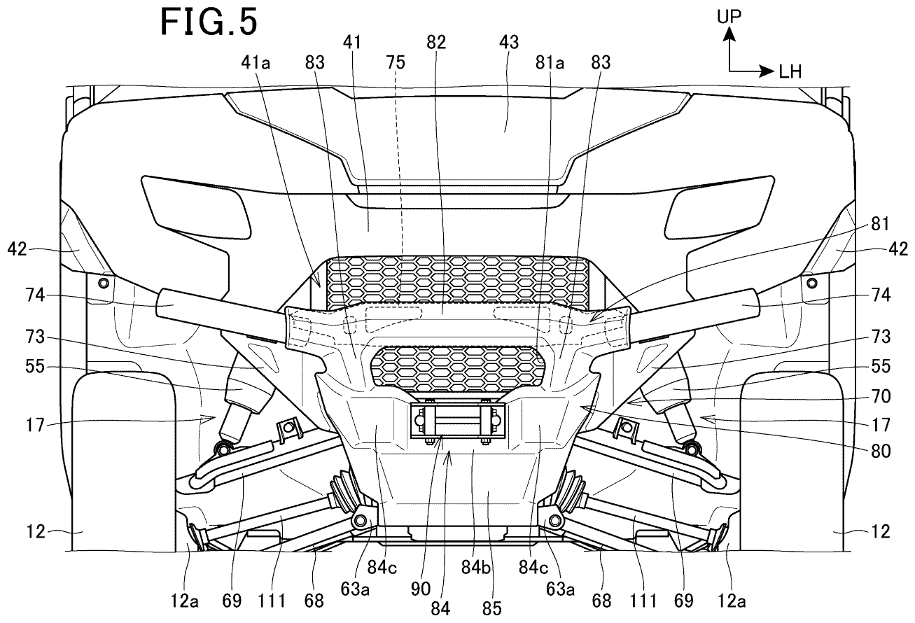

FIG. 4 is a perspective view of the irregular ground travel vehicle 10 when the peripheral portion of a bumper 70 is viewed from upper left. FIG. 5 is a front view of the irregular ground travel vehicle 10, and illustrates a peripheral portion of the bumper 70.

The bumper 70 is fixed to the bumper stay 66. As illustrated in FIGS. 2 and 3, the bumper 70 includes a pair of left and right bumper frame portions (bumper members) 71, which extend forward from the bumper stay 66. The bumper frame portion 71 has a square pipe shape. The bumper frame portion 71 is inserted into the bumper stay 66, and is fixed to the bumper stay 66. A bumper front surface portion 80, which has a plate shape, and which extends in an up-down direction, is supported at a front end portion of the bumper frame portion 71. The bumper front surface portion 80 extends in the left-right direction.

A bumper gusset portion 73, which extends upward, is supported on an outer side in the vehicle width direction of the bumper front surface portion 80. The pair of bumper gusset portions 73 are provided on the left and right. The bumper gusset portion 73 looks like an inverted triangle in a vehicle front view. Above the bumper gusset portion 73, a bumper pipe portion 74, which extends rearward and upward toward the outer side in the vehicle width direction, is fixed. The bumper pipe portion 74 has a round pipe shape. The pair of bumper pipe portions 74 are provided on the left and right.

A bumper back surface portion 75, which has a plate shape, and which extends in the left-right direction, is fixed to a back surface of the bumper pipe portion 74. The bumper back surface portion 75 and the bumper front surface portion 80 hold and fix the bumper pipe portion 74.

The bumper 70 according to the present embodiment includes: the pair of left and right bumper frame portions (square pipes) 71; the bumper front surface portion (a plate member) 80; the pair of left and right bumper gusset portions (plate members) 73; the pair of left and right bumper pipe portions (round pipes) 74; and the bumper back surface portion (a plate member) 75. Note that the bumper 70 may include any other pipe or plate member.

As illustrated in FIG. 2, a front wheel final case 110, which includes a differential device and a deceleration mechanism, is disposed between the front lower frame 63 and the front upper frame 65. The front wheel final case 110 is disposed between the front and rear vertical frame portions 64a and 64c of the cushion support frame 64 in the vehicle side view. A front propeller shaft (not illustrated), which extends forward from a power unit (not illustrated), is connected with the front wheel final case 110. A pair of left and right front wheel drive shafts 111 (see FIG. 4) are connected with the front wheel final case 110. The front wheel drive shaft 111 is connected with the front wheel 12. The front wheel drive shaft 111 transmits the driving force to the front wheel 12.

A radiator 120 is disposed on the front, above the front wheel final case 110. The radiator 120 is disposed above the bumper stay 66. Therefore, the radiator 120 is positioned on the rear of the bumper 70. The radiator 120 has a rectangular parallelepiped shape in appearance. The radiator 120 includes a core 122, which has a substantially plate shape, and which has a thickness in the front-rear direction. A condenser core (A refrigerant cooling unit of an air-conditioner. The air-conditioner is not illustrated.) 121, which has the same shape as the core 122, is disposed on the front of the core 122. The core 122 and the condenser core 121 are arranged to overlap each other in the front-rear direction. The radiator 120 is covered with the front cover 41. Specifically, a lower half part or more of the radiator 120 is covered from the front with a grille portion 41a, which is included in the front cover 41. A refrigerant pipe 123, which is connected with the power unit, is connected with the radiator 120.

A winch 130 is disposed below the radiator 120. The winch 130 is disposed below the bumper frame portion 71 and on the front of the vertical frame portion 64a of the cushion support frame 64. The winch 130 includes a reel 131, which has a cylindrical shape around which a wire (not illustrated) is windable. The reel 131 is rotatably supported by a housing 132.

As illustrated in FIGS. 2 and 3, the housing 132 includes: a pair of left and right side plate portions (housing portions) 133, each of which has a plate shape; and a connection plate portion 134, which has a plate shape, and which connects between the left and right side plate portions 133. The side plate portion 133 includes a front edge portion (a front face) 135. A support hole 133a, which penetrates in the thickness direction, and a fixing portion 133b, which is provided above the support hole 133a, are formed in the side plate portion 133. The reel 131 is rotatably mounted in the support hole 133a. The fixing portion 133b is disposed on an outer side in the vehicle width direction of the bumper stay 66. The fixing portion 133b is fixed to the bumper stay 66 with a fastening member.

In this situation, the housing 132 is fixed with the front edge portion 135 inclined rearward and upward. Thus, the traveling wind easily moves along the left and right front edge portions 135 and the side surfaces of the reel 131 between them, and is easily guided to the radiator 120, which is positioned above. In addition, the fastening member penetrates into and is fixed to the bumper frame portion 71 in the bumper stay 66. That is, the fixing portion 133b of the housing 132 is fastened together with the bumper frame portion 71, and they are fixed to the bumper stay 66. In other words, the fixing portion 133b of the housing 132 is fixed to the bumper frame portion 71, and is thus fixed to the bumper stay 66.

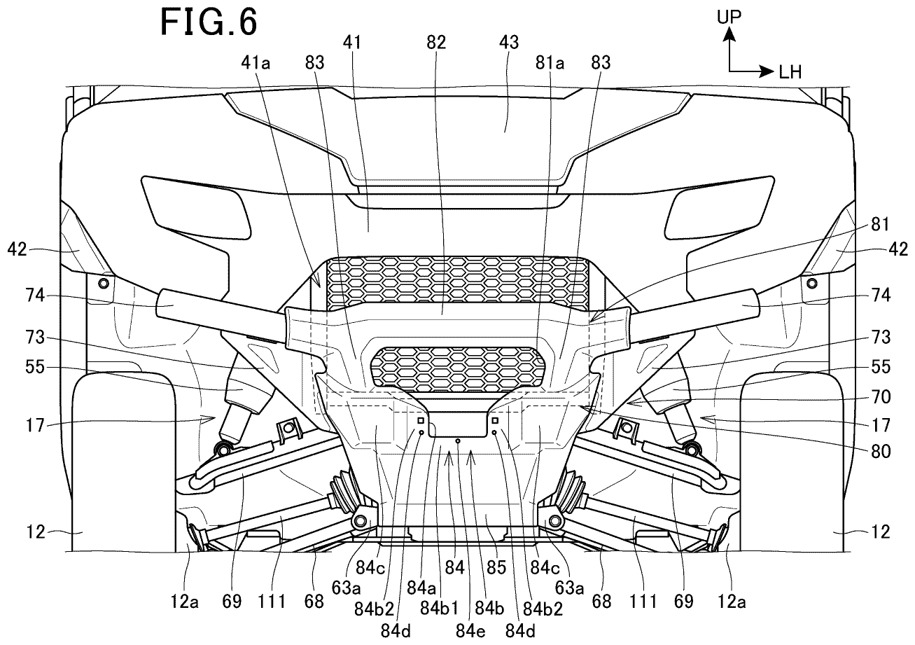

FIG. 6 is a view illustrating a state in which a guide roller unit 90 is removed from FIG. 5.

As illustrated in FIG. 2, in the vehicle side view, the bumper front surface portion 80 of the bumper 70 includes: a front surface portion main body portion 81, which extends in the up-down direction; and a skid plate portion 85, which extends rearward and downward from a lower end of the front surface portion main body portion 81. The skid plate portion 85 is fixed at a rear end portion to a front end of the front lower frame 63.

The front surface portion main body portion 81 includes an upward extension portion (a surrounding portion) 82, which extends in the left-right direction. The upward extension portion 82 is provided to correspond to an intermediate position in the up-down direction of the grille portion 41a. As illustrated in FIG. 2, the upward extension portion 82 has a substantially letter U shape in cross-section with a rear portion opened. The upward extension portion 82 is formed in a tapered shape in which an opening width increases toward the rear. Specifically, the upward extension portion 82 includes: a front surface portion 82a, which extends in the left-right direction; an upper surface portion (a tapered portion) 82b, which extends rearward and upward from an upper end of the front surface portion 82a; and a lower surface portion (a tapered portion) 82c, which extends rearward and downward from a lower end of the front surface portion 82a. The bumper pipe portion 74 of the bumper 70 is accommodated in an inner back surface of the upward extension portion 82, that is, in the surrounding shape of the front surface portion 82a, the upper surface portion 82b, and the lower surface portion 82c. The upward extension portion 82 is fixed to the bumper pipe portion 74.

As illustrated in FIG. 6, column portions 83, which extend downward, are respectively formed at both left and right end portions of the upward extension portion 82. A pair of left and right column portions 83 are provided. The column portion 83 is inclined inward in the vehicle width direction toward the lower side. A base portion 84, which extends in the vehicle width direction, is formed at a lower end of the column portion 83. The base portion 84 includes: left and right connection portions 84c, which are respectively connected with the left and right column portions 83; and a central portion 84b, which is provided between the left and right connection portions 84c. The central portion 84b is formed to be recessed rearward relative to the left and right connection portions 84c. A ventilation port (a wind guide portion) 81a, through which the traveling wind passes in the front-rear direction, is formed in the surrounding shape of the base portion 84, the column portions 83, and the upward extension portion 82. The ventilation port 81a overlaps a lower portion of the grille portion 41a in the vehicle front view. An opening-shaped inner peripheral portion of the ventilation port 81a is inclined so that an opening width of the ventilation port 81a is narrower toward the rear.

On an upper edge of the central portion 84b of the base portion 84, a cutout portion 84a, which is cut out downward in an opened shape, is formed. In other words, the central portion 84b includes: a central portion lower portion 84b1, which extends in the left-right direction; and a pair of left and right central portion side portions 84b2, which respectively extend upward from both left and right ends of the central portion lower portion 84b1. The cutout portion 84a is formed in the surrounding shape with the central portion lower portion 84b1 and the left and right central portion side portions 84b2. A fixing hole 84d, which penetrates in the front-rear direction, is formed in the central portion side portion 84b2. A fixing hole 84e, which penetrates in the front-rear direction, is formed in the central portion lower portion 84b1. For example, the guide roller unit 90 (see FIGS. 4 and 5), which guides the wire of the winch 130 (see FIGS. 2 and 3), is fixed to the fixing holes 84d and 84e.

As illustrated in FIG. 4, the guide roller unit (a guide member) 90 includes: a pair of left and right guide rollers 91; a pair of upper and lower guide rollers 92, which are disposed on the rear of the pair of left and right guide rollers 91; and a stay portion 93, which supports the guide rollers 91 and 92. The guide roller unit 90 guides the wire extending from the winch 130. The wire is drawn out forward from the reel 131 (see FIG. 3) of the winch 130, and is then drawn out through the cutout portion 84a of the bumper front surface portion 80 to the guide roller unit 90. Then, in the guide roller unit 90, the wire is drawn out forward between the pair of upper and lower guide rollers 92 and between the pair of left and right guide rollers 91.

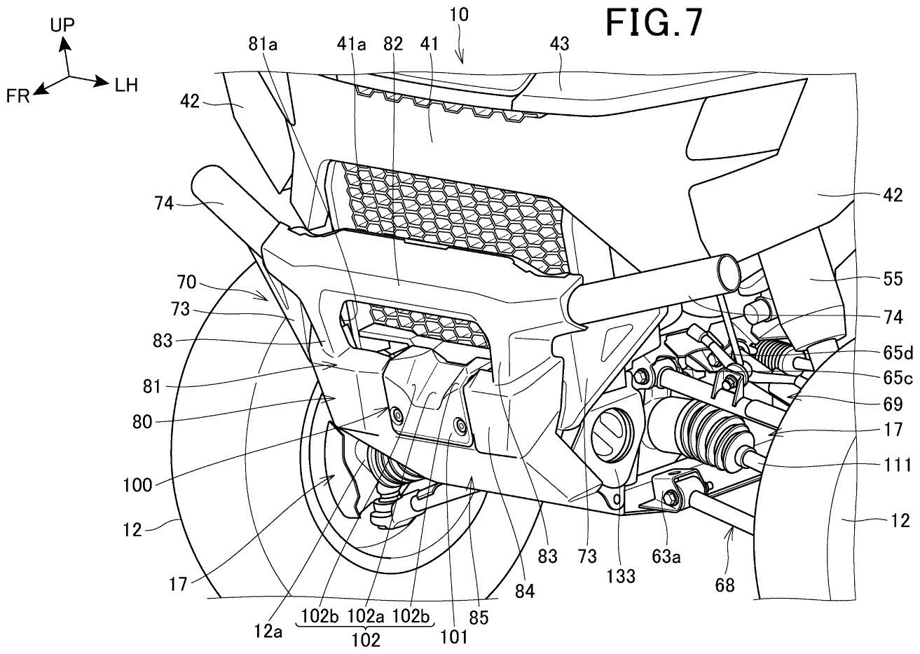

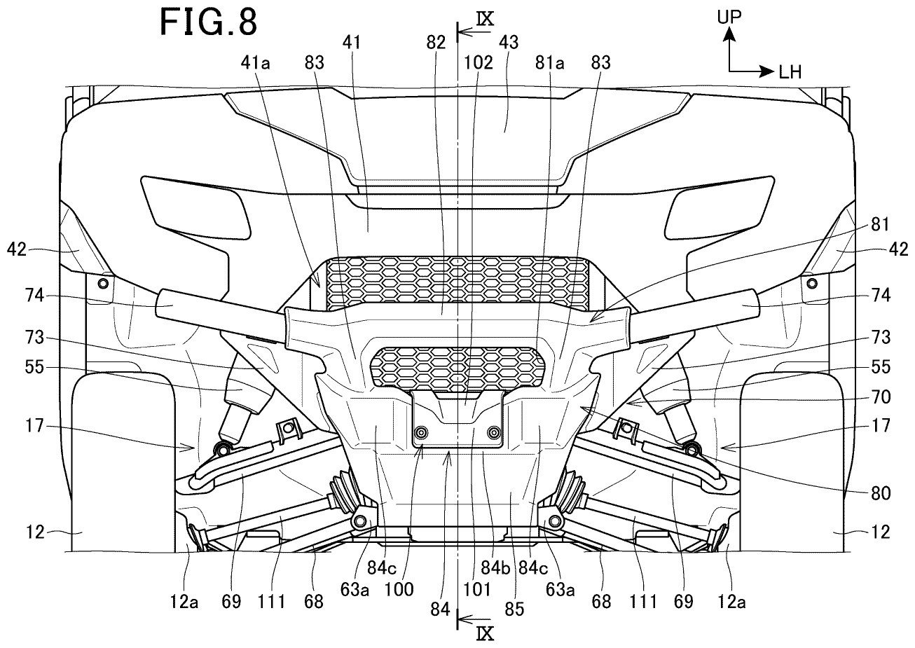

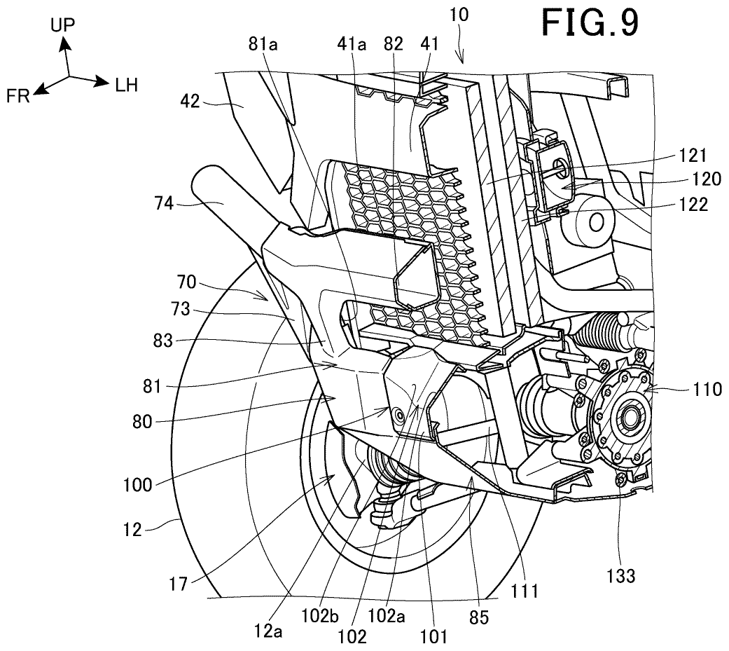

FIG. 7 is a perspective view of the irregular ground travel vehicle 10 when the peripheral portion of the bumper 70, with which a wind guide cover 100 is attached, is viewed from upper left. FIG. 8 is a front view of the irregular ground travel vehicle 10, and illustrates the peripheral portion of the bumper 70 in a case where the wind guide cover 100 is attached. FIG. 9 is a perspective view corresponding to a cross-section taken along line IX-IX in FIG. 8.

On the bumper front surface portion 80, the wind guide cover (the cover member) 100 is selectively provided instead of the guide roller unit 90.

The wind guide cover 100 includes a front surface portion 101, which is fixed to the fixing hole 84d of the bumper front surface portion 80. A central portion in the vehicle width direction of the front surface portion 101 is recessed downward. A wind guide surface portion (an inclined surface) 102, which extends rearward and upward from an upper edge of the front surface portion 101, is formed in an upper portion of the front surface portion 101. A rear end portion of the wind guide surface portion 102 is positioned at a lower end portion of the grille portion 41a. The wind guide surface portion 102 includes: a central wind guide surface portion 102a, which has a planar shape, and which extends rearward and upward; and side wind guide surface portions 102b, which are formed on both sides in the vehicle width direction of the central wind guide surface portion 102a, and which are inclined upward as being separated from the central wind guide surface portion 102a. The side wind guide surface portion 102b also extends rearward and upward.

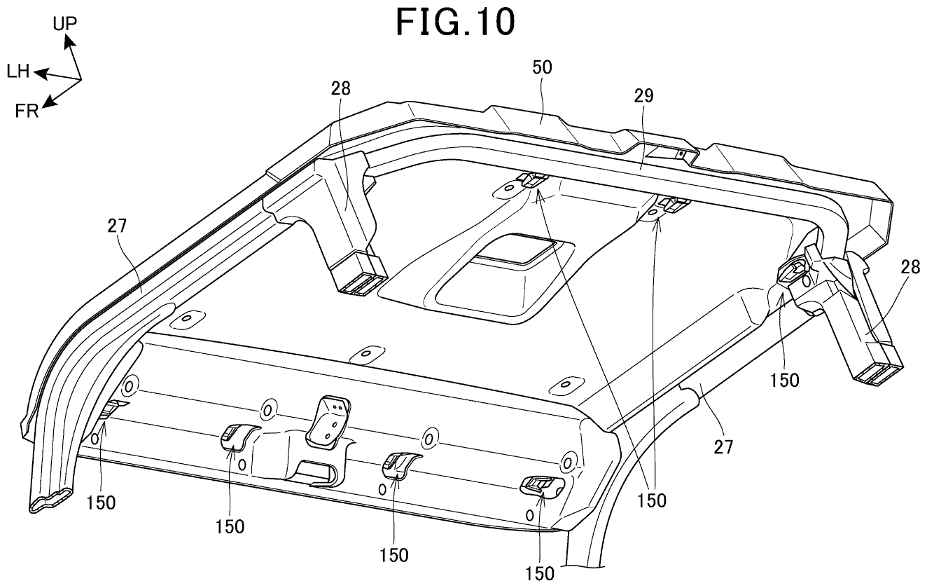

FIG. 10 is a perspective view of a peripheral portion of the roof 50 of the irregular ground travel vehicle 10 when viewed from lower left.

The roof 50 is provided on the irregular ground travel vehicle 10. The roof 50 is attached to the upper frame 26 via a plurality of clip members 150.

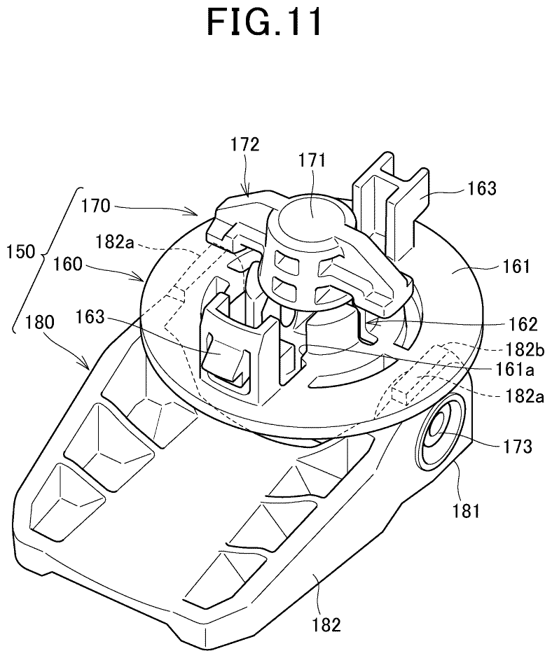

FIG. 11 is a perspective view of the clip member 150.

The clip member 150 includes: a fixing portion 160, which is fixed to the upper frame 26; an engagement shaft member 170, which is rotatably supported by the fixing portion 160; and an operation lever 180, which is swingably supported by the engagement shaft member 170.

The fixing portion 160 includes a fixed bearing surface 161, which has a disk shape. A shaft hole 161a, which penetrates in the thickness direction, is formed at the center portion of the fixed bearing surface 161. A shaft support portion 162, which has a substantially cylindrical shape split in the circumferential direction, is formed around the shaft hole 161a. A pair of claw portions 163 are formed around the shaft support portion 162 so as to sandwich the shaft support portion 162.

The engagement shaft member 170 is attached to the shaft hole 161a. The engagement shaft member 170 includes: a shaft portion 171, which is rotatably supported by the shaft hole 161a of the fixed bearing surface 161; an engagement portion 172, which is provided at one end portion of the shaft portion 171; and a hinge shaft portion 173, which is provided at the other end portion of the shaft portion 171. The engagement portion 172 protrudes on both sides in the radial direction of the shaft portion 171 with the shaft portion 171 as the center. The hinge shaft portion 173 is orthogonal to the shaft portion 171. The operation lever 180 is rotatably supported by the hinge shaft portion 173.

The operation lever 180 includes: a base portion 181, which is rotatably supported by the hinge shaft portion 173; and a lever extension portion 182, which extends from the base portion 181 in the radial direction of the hinge shaft portion 173.

An abutment portion 182a, which abuts the fixed bearing surface 161 in a case where the lever extension portion 182 extends along the fixed bearing surface 161, is formed on the base portion 181. The abutment portion 182a is formed in an elongated protrusion shape that protrudes relative to the base portion 181. A maximum diameter portion 182b, which has the largest distance from the hinge shaft portion 173, is formed at an end of the abutment portion 182a. The abutment portion 182a abuts the fixed bearing surface 161, and thus the attitude of the operation lever 180 along the fixed bearing surface 161 is maintained.

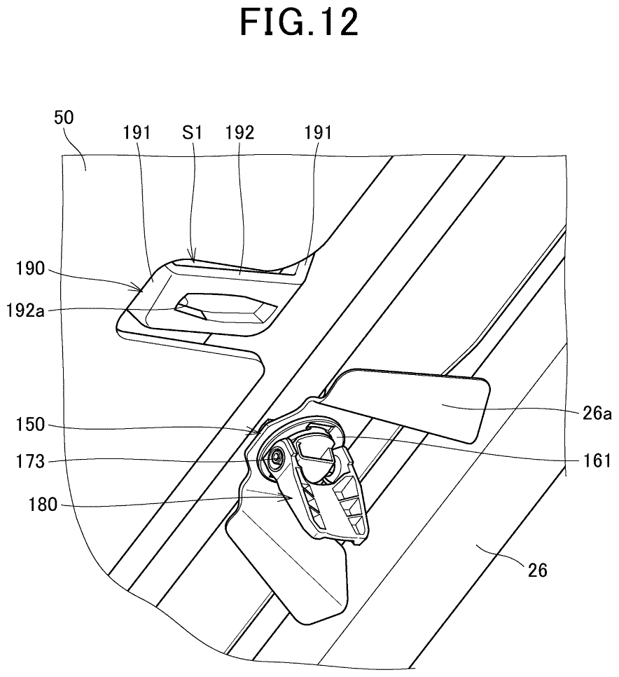

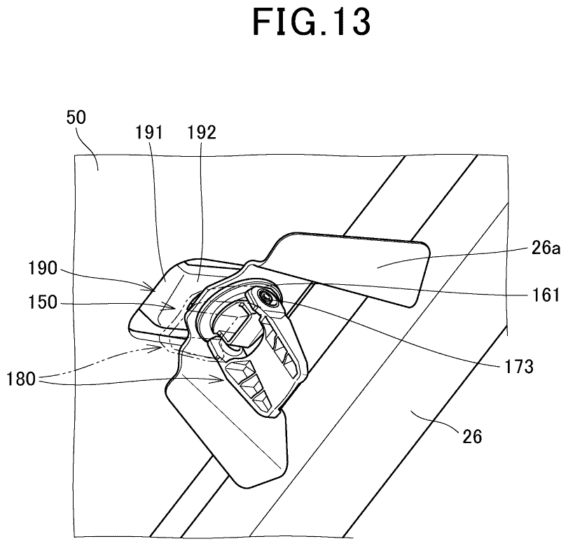

FIG. 12 is an explanatory view of the clip member 150 of the upper frame 26 and an engagement receiving portion 190 of the roof 50. FIG. 13 is an explanatory view when the clip member 150 of the upper frame 26 and the engagement receiving portion 190 of the roof 50 are engaged with each other.

A clip support stay 26a is provided on the upper frame 26. A circular attachment hole (not illustrated) is formed in the clip support stay 26a. In a state in which the clip member 150 is inserted into the attachment hole, the clip member 150 is supported by the clip support stay 26a.

Specifically, the pair of claw portions 163 are inserted to be pushed into the attachment hole, the pair of claw portions 163 elastically returns when passing through the attachment hole, and thus the clip member 150 engages with the clip support stay 26a. That is, the clip support stay 26a is sandwiched between the claw portions 163 and the fixed bearing surface 161. In this situation, in the clip member 150, the engagement portion 172 of the engagement shaft member 170 is held on the upper side of the clip support stay 26a, and the operation lever 180 is held on the lower side of the clip support stay 26a.

The engagement receiving portion 190 is fixed to an inner surface of the roof 50, that is, a lower surface of the roof 50. The engagement receiving portion 190 has a substantially letter U shape. Specifically, the engagement receiving portion 190 includes: a pair of leg portions 191, which are fixed to the roof 50; and a bridge portion 192, which is formed between lower ends of the pair of leg portions 191. The bridge portion 192 is spaced apart from the roof 50. The bridge portion 192 forms a rotation space S1 where the engagement portion 172 rotates between the bridge portion 192 and the lower surface of the roof 50. An engagement hole 192a, which has a long hole shape, and which extends along the longitudinal direction of the bridge portion 192, is formed in the bridge portion 192. The engagement hole 192a is formed in a size through which the engagement portion 172 of the engagement shaft member 170 is allowed to pass. In addition, the width of the engagement hole 192a is formed to be smaller than a protrusion amount of the engagement portion 172 relative to the shaft portion 171.

As illustrated in FIGS. 12 and 13, when the roof 50 is attached to the upper frame 26, the roof 50 is subjected to alignment. That is, the roof 50 is aligned so that the engagement receiving portion 190 faces the clip member 150. Then, the engagement receiving portion 190 is moved toward the clip member 150, and the engagement portion 172 of the clip member 150 is made to enter the engagement hole 192a of the engagement receiving portion 190.

In this situation, when the operation lever 180 of the clip member 150 illustrated in FIG. 12 is rotated about the shaft portion 171, the engagement portion 172 is rotated and moved to the back surface of the engagement receiving portion 190 (see FIG. 13). Thus, the engagement receiving portion 190 is in a state of being prevented from coming off by the engagement portion 172, and the roof 50 cannot be detached from the clip member 150. Then, when the operation lever 180 of the clip member 150 is rotated about the hinge shaft portion 173, the maximum diameter portion 182b comes into contact with the fixed bearing surface 161 while in rotation. Then, when the operation lever 180 is further moved to separate the maximum diameter portion 182b from the fixed bearing surface 161, the operation lever 180 moves to a fixed position (see two-dot chain lines in FIG. 13) extending along the fixed bearing surface 161. In this timing, the abutment portion 182a becomes capable of abutting the engagement receiving portion 190, and the movement of the operation lever 180 of the clip member 150 is restricted.

In this manner, the roof 50 is easily attached to the upper frame 26.

As described heretofore, according to the present embodiment to which the present invention is applied, in an irregular ground travel vehicle 10 including: the vehicle body frame 11; the left and right front wheels 12 and at least one rear wheel 13, which are provided on the vehicle body frame 11; the radiator 120, which is disposed between the left and right front wheels 12; the front cover 41, which includes the grille portion 41a for introducing traveling wind, which is positioned on the front of the radiator 120, and which covers at least the upper portion of the radiator 120; the winch 130, which is disposed below the radiator 120; and the bumper 70, which is supported by the vehicle body frame 11, and which is positioned on the front of the grille portion 41a, the bumper front surface portion 80 of the bumper 70 includes the opening that forms the ventilation port 81a on the surface overlapping the grille portion 41a in the vehicle front view, the cutout portion 84a, which is connected with the ventilation port 81a, and from which the wire of the winch 130 is taken out, is provided below the ventilation port 81a, and either the guide roller unit 90 to be used when the winch 130 is used or the wind guide cover 100 to be used when the winch 130 is not used is selectively provided for the cutout portion 84a.

According to this configuration, the ventilation port 81a is included, and thus the traveling wind can be easily introduced into the radiator 120, even though the bumper front surface portion 80 of the bumper 70 is provided to overlap the radiator 120 on the front of the radiator 120. In addition, when the winch 130 is not used, the wind guide cover 100 is provided to make it difficult to expose the cutout portion 84a from which the wire of the winch 130 is taken out in appearance, and also to make it possible to guide the traveling wind to the ventilation port 81a without causing the traveling wind to enter the cutout portion 84a. Therefore, according to this configuration, in the irregular ground travel vehicle 10 in which the cutout portion 84a for taking out the wire of the winch 130 is provided on the bumper 70, it becomes possible to guide the wind to the radiator 120 although the cutout portion 84a is provided, and to also make the cutout portion 84a less conspicuous in appearance.

In the present embodiment, the cutout portion 84a is positioned below an intermediate height H0 (see FIG. 2) of the radiator 120.

According to this configuration, by positioning the cutout portion 84a below the ventilation port 81a, it becomes possible to easily provide the ventilation port 81a to be large, so that the traveling wind can be easily introduced from the ventilation port 81a. In addition, the upper side of the wind guide cover 100 also serves as a member for defining the ventilation port 81a, and thus the appearance is improved, and in addition, the traveling wind can be easily guided to the ventilation port 81a.

In addition, according to the present embodiment, the wind guide surface portion 102, which is inclined upward toward the rear, is provided on the upper surface of the wind guide cover 100.

According to this configuration, the traveling wind can be actively guided to the ventilation port 81a.

In addition, according to the present embodiment, the bumper 70 is configured with a combination of the bumper pipe portion 74, the bumper gusset portion 73, the bumper back surface portion 75, and the bumper front surface portion 80. A joint portion of the bumper gusset portion 73, the bumper back surface portion 75, the bumper front surface portion 80, and the bumper pipe portion 74 includes the upward extension portion 82, which has a shape that the bumper front surface portion 80 surrounds the bumper pipe portion 74, and the upward extension portion 82 includes the upper surface portion 82b and the lower surface portion 82c, which form a tapered shape above and below the bumper pipe portion 74.

According to this configuration, it becomes possible to easily guide the traveling wind using the upward extension portion 82 having a shape that surrounds the bumper front surface portion 80 of the bumper 70 having a tapered shape.

Further, in the present embodiment, the winch 130 is supported by the bumper frame portion 71, which is supported by the vehicle body frame 11 below the radiator 120.

According to this configuration, the winch 130 is disposed in a space below the radiator 120, so that the traveling wind can easily flow toward the radiator 120.

In addition, according to the present embodiment, the winch 130 supports the reel 131 to be rotatable with the left and right side plate portions 133, and the housing 132 is attached to be inclined in such a manner that the front edge portion 135 is positioned forward toward its bottom end.

According to this configuration, the front edge portion 135 of the housing 132 enables the traveling wind to be actively guided to the radiator 120.

### Second Embodiment

A second embodiment will be described. In the second embodiment, parts configured in similar manners to the first embodiment are denoted by the same reference numerals, and their description will be omitted.

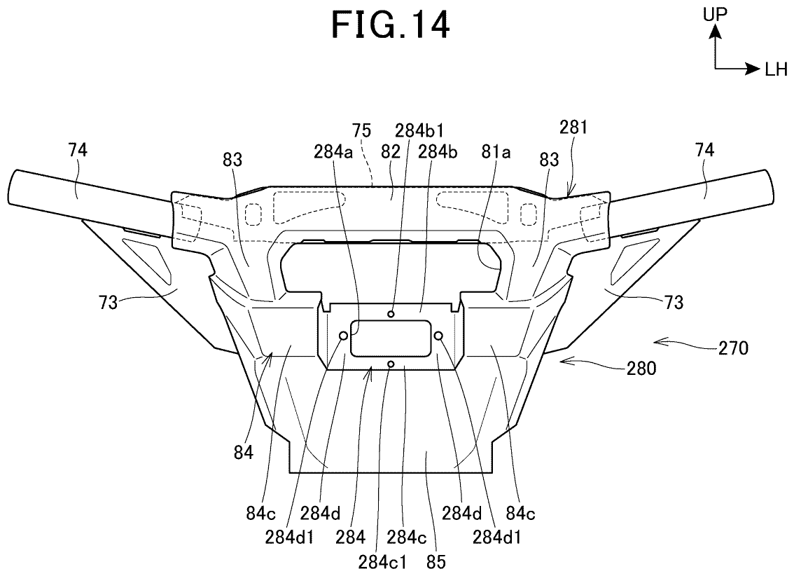

FIG. 14 is a front view of a bumper 270 in an irregular ground travel vehicle 10 according to a second embodiment of the present invention.

The irregular ground travel vehicle 10 according to the second embodiment includes the bumper 270 according to the second embodiment instead of the bumper 70 according to the first embodiment.

The bumper 270 according to the second embodiment is different from the bumper 70 according to the first embodiment in that the central portion 84b is made up of a plate-shaped member 284, which is a separate component.

The plate-shaped member 284 is fixed to the back surface of a front surface portion main body portion 281 of a bumper front surface portion 280. A wire outlet 284a, which penetrates in the thickness direction, is formed in the plate-shaped member 284. In other words, the plate-shaped member 284 includes: a plate-shaped portion upper portion 284b; a plate-shaped portion lower portion 284c; and plate-shaped portion side portions 284d, which connect the plate-shaped portion upper portion 284b with the plate-shaped portion lower portion 284c on the left and right. The wire outlet 284a is made up of a surrounding shape of the plate-shaped portion upper portion 284b, the plate-shaped portion lower portion 284c, and the left and right plate-shaped portion side portions 284d.

A fixing hole 284d1, which penetrates in the front-rear direction, is formed in the plate-shaped portion side portion 284d. The fixing hole 284d1 has functions similar to the fixing hole 84d according to the first embodiment.

Fixing holes 284b1 and 284c1, which penetrate in the front-rear direction, are respectively formed in the plate-shaped portion upper portion 284b and the plate-shaped portion lower portion 284c. The fixing holes 284b1 and 284c1 have functions similar to the fixing hole 84e according to the first embodiment.

As described heretofore, according to the present embodiment to which the present invention is applied, the bumper front surface portion 280 of the bumper 270 includes the opening that constitutes the ventilation port 81a on the surface overlapping the grille portion 41a in the vehicle front view, the wire outlet 284a for taking out the wire of the winch 130 is provided below the ventilation port 81a, and either the guide roller unit 90 to be used when the winch 130 is used or the wind guide cover 100 to be used when the winch 130 is not used is selectively provided in the peripheral portion of the wire outlet 284a.

Therefore, in the irregular ground travel vehicle 10 in which the wire outlet 284a for taking out the wire of the winch 130 is provided on the bumper 70, also in the second embodiment, it becomes possible to guide the wind to the radiator 120 although the wire outlet 284a is provided, and to also make the wire outlet 284a less conspicuous in appearance.

### Other Embodiments

The above-described embodiments merely describe one aspect of the present invention, and can be optionally modified and applied without departing from the gist of the present invention.

In the above embodiments, the configuration of the MUV as the irregular ground travel vehicle has been described as an example of the vehicle. However, any irregular ground vehicle other than the MUV, for example, a four-wheeled vehicle or a three-wheeled vehicle classified as ATV may be used, or any vehicle other than the irregular ground travel vehicle may be used.

In the above embodiments, the MUV including the pair of left and right front wheels 12 and the pair of left and right rear wheels 13 has been described as an example of the irregular ground travel vehicle 10. However, one rear wheel 13 may be applicable, and a so-called tricycle may be used as the vehicle.

### Configuration Supported by the Above Embodiments

The above embodiments support the following configurations.

(Configuration 1) A vehicle including: a vehicle body frame; left and right front wheels and at least one rear wheel, which are provided on the vehicle body frame; a radiator disposed between the left and right front wheels; a front cover, which includes a grille portion for introducing traveling wind, which is positioned on front of the radiator, and which covers at least an upper portion of the radiator; a winch disposed below the radiator; and a bumper, which is supported by the vehicle body frame, and which is positioned on the front of the grille portion, in which the bumper includes an opening that forms a wind guide portion on a surface overlapping the grille portion in a vehicle front view, either an opening portion or a cutout portion is provided below the wind guide portion, the opening portion being for taking out a wire of the winch, the cutout portion being connected with the wind guide portion and being for taking out the wire of the winch, and either a guide member to be used when the winch is used or a cover member to be used when the winch is not used is selectively provided for either the opening portion or the cutout portion.

According to this configuration, the wind guide portion is included, and thus the traveling wind can be easily introduced into the radiator, even though the bumper is provided to overlap the radiator on the front of the radiator. In addition, when the winch is not used, the cover member is provided to make it difficult to expose either the opening portion or the cutout portion from which the wire of the winch is taken out in appearance, and also to make it possible to guide the traveling wind to the wind guide portion without causing the traveling wind to enter either the opening portion or the cutout portion from which the wire of the winch is taken out. Therefore, according to this configuration, in the vehicle in which either the opening portion or the cutout portion for taking out the wire of the winch is provided on the bumper, it becomes possible to guide the wind to the radiator although either the opening portion or the cutout portion is provided, and to also make either the opening portion or the cutout portion less conspicuous in appearance.

(Configuration 2) The vehicle described in the configuration 1, in which either the opening portion or the cutout portion is positioned below an intermediate height of the radiator.

According to this configuration, by positioning either the opening portion or the cutout portion below the wind guide portion, it becomes possible to easily provide a large wind guide portion, so that the traveling wind can be easily introduced from the wind guide portion. In addition, the upper side of the cover member also serves as a member for defining the wind guide portion, and thus the appearance is improved, and in addition, the traveling wind can be easily guided to the wind guide portion.

(Configuration 3) The vehicle described in the configuration 1 or 2, in which an inclined surface inclined upward toward rear is provided on an upper surface of the cover member.

According to this configuration, the traveling wind can be actively guided to the wind guide portion.

(Configuration 4) The vehicle described in the configuration 1, in which the bumper includes a combination of a round pipe and a plate member, a joint portion of the plate member and the round pipe includes a surrounding portion having a shape that the plate member surrounds the round pipe, and the surrounding portion includes a tapered portion, which forms a tapered shape above and below the round pipe.

According to this configuration, it becomes possible to easily guide the traveling wind using the bumper having a tapered shape.

(Configuration 5) The vehicle described in one of the configurations 1 to 4, in which the winch is supported by a bumper member supported by the vehicle body frame below the radiator.

According to this configuration, the winch is disposed in a space below the radiator, so that the traveling wind can easily flow toward the radiator.

(Configuration 6) The vehicle described in one of the configurations 1 to 5, in which the winch supports a reel to be rotatable with left and right housing portions, and the housing is attached to be inclined in such a manner that a front surface is positioned forward toward a bottom end of the front surface.

According to this configuration, the front surface of the housing enables the traveling wind to be actively guided to the radiator.

### REFERENCE SIGNS LIST

10 Irregular ground travel vehicle (vehicle)
11 Vehicle body frame
12 Front wheel
13 Rear wheel
41 Front cover
41a Grille portion
70 Bumper
71 Bumper frame portion (bumper member)
73 Bumper gusset portion (plate member)
74 Bumper pipe portion (round pipe)
75 Bumper back surface portion (plate member)
80 Bumper front surface portion (plate member)
81a Ventilation port (wind guide portion)
82 Upper extension portion (surrounding portion)
82b Upper surface portion (tapered portion)
82c Lower surface portion (tapered portion)
84a Cutout portion
90 Guide roller unit (guide member)
100 Wind guide cover (cover member)
102 Wind guide portion (inclined surface)
120 Radiator
130 Winch
131 Reel
132 Housing
133 Side plate portion (housing portion)
135 Front edge (front surface)
270 Bumper
284a Wire outlet (opening portion)

What is claimed is:

1. A vehicle comprising: a vehicle body frame; left and right front wheels and at least one rear wheel, which are provided on the vehicle body frame; a radiator disposed between the left and right front wheels; a front cover, which includes a grille portion for introducing traveling wind, which is positioned on front of the radiator, and which covers at least an upper portion of the radiator; a winch disposed below the radiator; and a bumper, which is supported by the vehicle body frame, and which is positioned on the front of the grille portion, wherein
the bumper includes an opening that forms a wind guide portion on a surface overlapping the grille portion in a vehicle front view,
either an opening portion or a cutout portion is provided below the wind guide portion, the opening portion being for taking out a wire of the winch, the cutout portion being connected with the wind guide portion and being for taking out the wire of the winch, and
either a guide member to be used when the winch is used or a cover member to be used when the winch is not used is selectively provided for either the opening portion or the cutout portion.

2. The vehicle according to claim 1, wherein
either the opening portion or the cutout portion is positioned below an intermediate height of the radiator.

3. The vehicle according to claim 1, wherein
an inclined surface inclined upward toward rear is provided on an upper surface of the cover member.

4. The vehicle according to claim 1, wherein
the bumper includes a combination of a round pipe and a plate member,
a joint portion of the plate member and the round pipe includes a surrounding portion having a shape that the plate member surrounds the round pipe, and
the surrounding portion includes a tapered portion, which forms a tapered shape above and below the round pipe.

5. The vehicle according to claim 1, wherein
the winch is supported by a bumper member supported by the vehicle body frame below the radiator.

6. The vehicle according to claim 1, wherein
the winch supports a reel to be rotatable with left and right housing portions, and
the housing is attached to be inclined in such a manner that a front surface is positioned forward toward a bottom end of the front surface.
